(19) United States
(12) Patent Application Publication
(10) Pub. No.: US 2014/0360535 A1
(43) Pub. Date: Dec. 11, 2014

(54) PRODUCE CLEANSING UNIT AND METHOD

(71) Applicant: Karen ANDRUS, Shelby Township, MI (US)

(72) Inventor: Karen ANDRUS, Shelby Township, MI (US)

(21) Appl. No.: 14/104,857

(22) Filed: Dec. 12, 2013

Related U.S. Application Data
(60) Provisional application No. 61/797,621, filed on Dec. 12, 2012.

(51) Int. Cl. A47J 43/24

(52) U.S. Cl. CPC A47J 43/24
USPC 134/25.3; 134/199; 134/153

(57) ABSTRACT

A produce cleaning system having a housing member defining a base, a sidewall, and an open unit cavity therebetween. The sidewall may define a water compartment and a cleansing compartment. The system may include a lid configured to close the open unit cavity and one or more jet sprayers secured to an interior surface of the unit cavity. The jet sprayers may be configured to selectively disperse fluids from the water compartment and cleansing compartment toward the basket. The system may include an interface configured to receive operation commands based on user input including a rinse command and cleansing command, such that the rinse command includes instructions to direct the jet sprayers to disperse fluid from the water compartment, and the cleansing command includes instructions to direct the jet sprayers to disperse fluids from both the water compartment and the cleansing compartment.

### CROSS-REFERENCE TO RELATED APPLICATIONS

This application claims the benefit of U.S. provisional application Ser. No. 61/797,621, filed Dec. 12, 2012, the disclosure of which is hereby incorporated in its entirety by reference herein.

### TECHNICAL FIELD

The present disclosure relates to a produce cleansing device and a method using the same.

### BACKGROUND

Pesticides are commonly used as a plant protection product that is meant for preventing, eliminating or mitigating any damage pests may inflict on the plants. The produce sold in your local supermarket may have been treated with pesticides and/or are susceptible to contaminants from the plant growing and/or distribution process. Most people hand wash fruits and vegetables before consuming, however washing by hand may be time consuming and if done incorrectly may not eliminate all the pesticides and contaminants from the fruit and/or vegetable.

Pesticides may pose several risks including physical symptoms such as impaired mental functions, disruption of hormone functions, and an increased risk of developing cancer. Physical symptoms due to pesticide exposure may also include respiratory problems and asthma, headaches, nausea, skin rashes, genetic damage linked to neurological disorders, and impaired immune functions. Mental symptoms due to pesticide exposure may include disorientation, attention problems, and fatigue.

### SUMMARY

In a first illustrative embodiment, a produce cleaning system having a housing member defining a base, a sidewall, and an open unit cavity therebetween, the sidewall defining a water compartment and a cleansing compartment. The system may include a basket configured to sit within the unit cavity and to receive produce. The system may include a lid configured to close the open unit cavity and one or more jet sprayers secured to an interior surface of the unit cavity. The jet sprayers may be configured to selectively disperse fluids from the water compartment and cleansing compartment toward the basket. The system may include an interface configured to receive operation commands based on user input including a rinse command and cleansing command, such that the rinse command includes instructions to direct the jet sprayers to disperse fluid from the water compartment, and the cleansing command includes instructions to direct the jet sprayers to disperse fluids from both the water compartment and the cleansing compartment.

In a second illustrative embodiment, a produce cleansing device having a housing member defining a base, a sidewall, and an open unit cavity therebetween, the sidewall defining one or more fluid cavities configured to store fluid. The device may include a spin mechanism supported by the base. The device may have a basket configured to sit within the unit cavity. The basket may have a center post with a center ring at one end and operatively connected to a spin latch at the other end, such that the spin latch is configured to mate with the spin mechanism. The basket may rotate with the spin mechanism. The device may have a lid configured to close the open unit cavity, and the lid may include a handle and a lock configured to engage the center ring of the basket. The device may have a plurality of jet sprayers secured to an interior surface of the unit cavity and configured to be in fluid communication with the one or more fluid cavities. The jet sprayers are oriented such that fluid disperses therefrom in a plurality of trajectories to contact multiple sides of produce within the basket.

In a third illustrative embodiment, a method for cleansing produce with a produce cleansing device by placing produce within a basket positioned within a unit cavity of the device. The basket may engage with a spin mechanism of the device. The method may include a motor activating to spin the spin mechanism and basket engaged therewith in response to user input to a speed spin dial. The method may have one or more jet sprayers positioned within the unit cavity and in communication with a fluid source activating to disperse fluid therefrom on multiple portions of the produce as the basket spins in response to user input to a start button.

### BRIEF DESCRIPTION OF THE DRAWINGS

FIG. 1 is a front perspective view of a produce cleansing unit;

FIG. 2 is a rear perspective view of the produce cleansing unit from FIG. 1;

FIG. 3 is a front perspective view of a basket for the produce cleansing unit from FIG. 1;

FIG. 4 is a front perspective view of the produce cleansing unit from FIG. 1 illustrating a spin dry feature and basket dividers;

FIG. 5 is a front perspective view of two baskets for the produce cleansing unit from FIG. 1 illustrating a spin dry feature and basket;

FIG. 6 is a front perspective view of the produce cleansing unit from FIG. 1 illustrating one or more spray nozzles and a spin mechanism positioned within the produce cleansing unit;

FIG. 7 is a front perspective view of the produce cleansing unit from FIG. 1 illustrating the spin mechanism; and

FIG. 8 is a front perspective view of a drain mechanism from the produce cleansing unit from FIG. 1.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

FIG. 1 shows an example of a produce cleansing unit 100 having a base 98 and a sidewall 99. The unit 100 may include a front lid 102 to cover the unit cavity 103 where a basket (described below) may be placed and a back lid 104 to cover a cleaner container 126 and a water container 124. The unit 100 may include an interface 101 having one or more circuits configured to communicate with an on/off switch 106, a start switch 108, a cleaner selector 110, a rinse only switch 112, a spin speed dial 114, and a hot water switch 116. The interface 101 may receive input from one or more switches or selectors and control the unit 100 based on the received input. The unit 100 may also include a liquid pan or drain pan 122 to receive drainage from the well 103. The unit 100 may include a hot water ready indicator light 118 and a full drain indicator light 120.

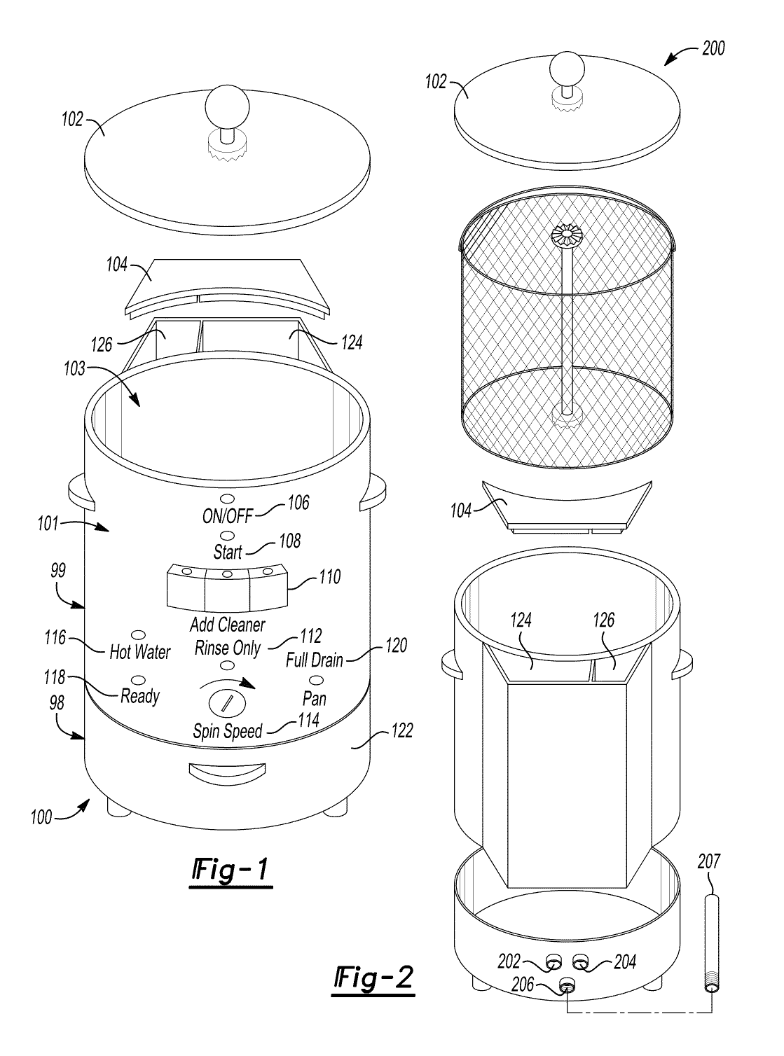

FIG. 2 is a rear view of the unit 100. A back portion 200 of the unit 100 may have a hot water port 202 and a cold water port 204 to provide an optional connection to an external water supply such as a faucet. The back portion 200 of the unit 100 may also have a drain plug 206 which may be removed to provide an optional connection of a drain hose 207. A water container 124 and a cleaner container 126 may be configured to be inserted and removed from a cavity defined by the back portion 200 of the unit 100.

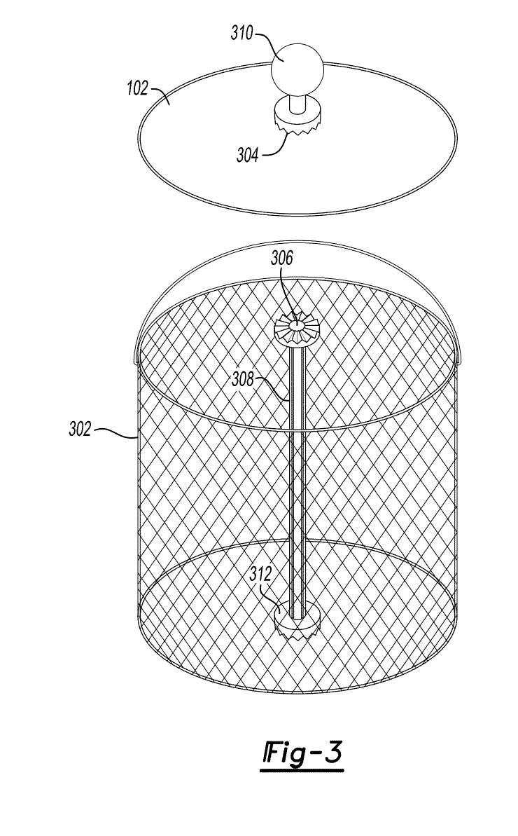

FIG. 3 shows one example of a basket 302 for inserting into the well 103 of the unit 100. The basket 302 may also be referred to as a well herein. The basket 302 may include a center post 308 having a spin latch 312 and center ring 306 at a top portion of the center post 308 to assist in locking a ball handle 310 to the basket 302 via a lock 304. When the lock 304 engages the center ring 306, and the spin latch 312 is engaged with a spin mechanism (described below) of the unit 100, a user may spin the basket 302 manually.

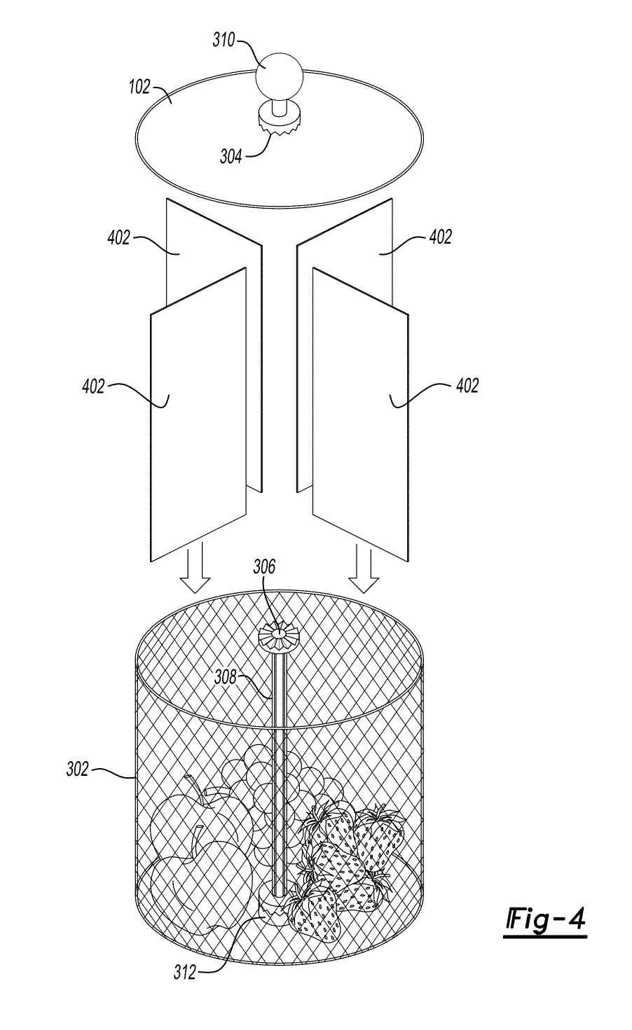

FIG. 4 shows an example of a spin dry feature and a produce separation feature of the unit 100. The basket 302 and center post 308 may include tracks or slots to receive a corresponding number of dividers 402 to separate produce positioned within the basket 302.

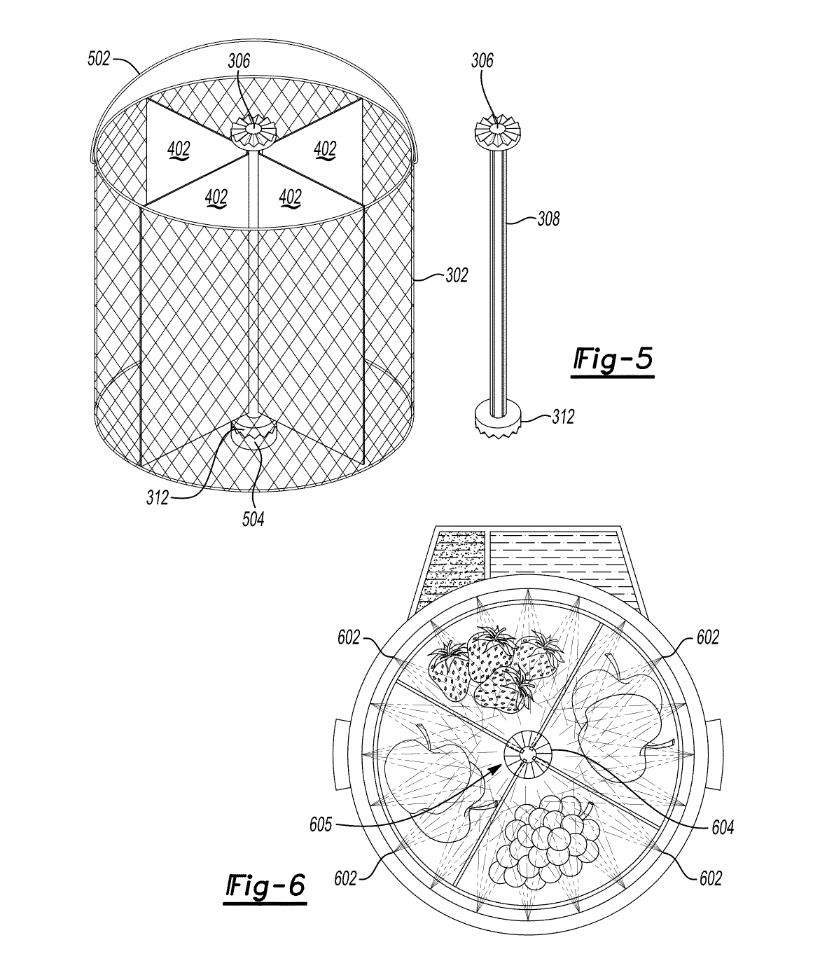

The unit cavity 103 may have two options for a type of basket or well to utilize during operations. FIG. 5 shows a first option which utilizes the basket 302 and also shows a second option which utilizes another example of a basket 508. As mentioned above, the basket 302 may include the center post 308 for use with a spin dry cycle and dividers 402. A handle 502 may assist in lowering the basket 302 into the well and removing the basket 302 from the well 103. The basket 508 may not include a center post or dividers to provide a larger space to receive large items of produce. The basket/well 302, 502 may have a handle.

FIG. 6 shows additional features positioned within the unit cavity 103 of the unit 100. For example, one or more jet sprayers 602 may be positioned within the unit cavity 103 that may spray water and/or cleaner. The jet sprayers 602 may be oriented in multiple directions, such as up and down, to disperse fluid in more than one trajectory such that fluid contacts multiple sides and/or portions of the produce within the unit cavity 103 as further described below. A spin mechanism 604 may be positioned at the bottom of the unit. The spin mechanism 604 may include a receiving element, or bottom spinner 605, which may engage the spin latch 312 or spin latch 504 such that the spin mechanism 604 and basket 302 or 508 may spin simultaneously.

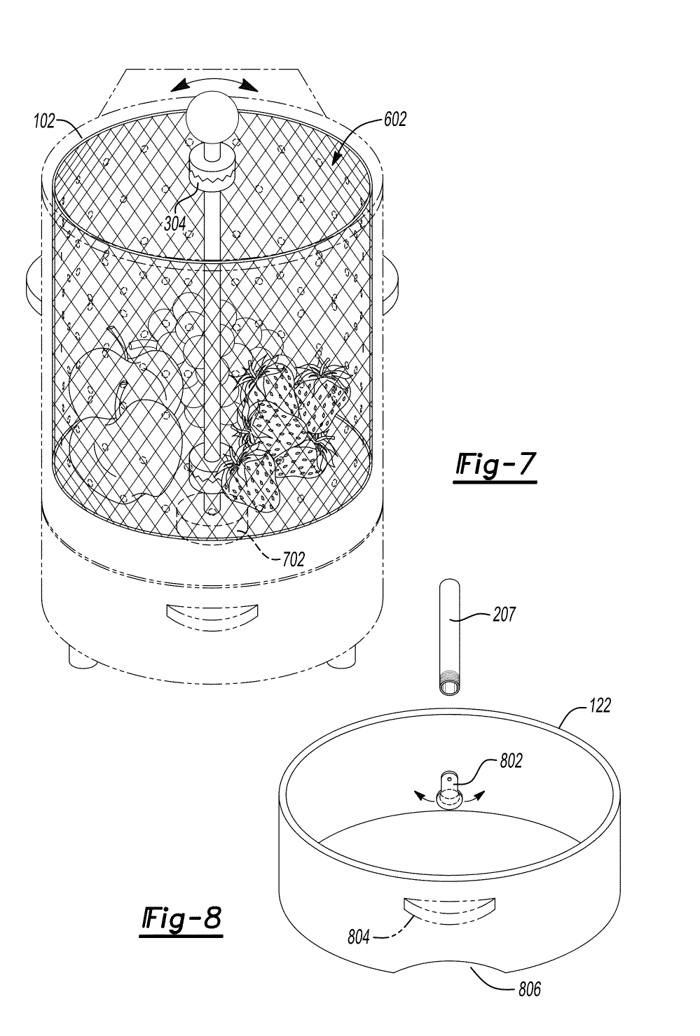

FIG. 7 shows an example a motorized spin feature of the unit 100. In this example, the basket 302 or 508 may be positioned within the unit cavity 103 and engaged with the spin mechanism 604 as described above. As mentioned above, the jet sprayers 602 may be positioned around the unit cavity 103 to cleanse the produce. Once the washing is done, a motor 702 in communication with the spin mechanism 604 may activate and spin the basket 302 or 508 to dry the produce contained therein. Now additionally referring to FIG. 8, a drain pan 122 may receive liquid from the cleansing process of the unit 100. The drain pan 122 may be positioned within a cavity of the unit 100 which is in fluid communication with the unit cavity 103. The drain pan 122 may have a flip spout 802 that flips up and rotates such that the drain hose 207 may attach to the flip spout 802 to remove fluid from the drain pan 122. The drain pan may have a handle 804 to assist in moving the drain pan 122 into and out of the unit 100. The drain pan 122 may have a notched space 806 instead of a handle 804 to assist in moving the drain pan 122 in and out of the unit 100.

Examples of unit 100 operations are now provided. Open the lid 104 in the back of the unit. Fill the containers 124, 126 from the back of the unit. Both containers 124, 126 are removable for easy access. The larger side 124 is for water and the other side 126 is for the cleaner, i.e. vinegar-water, lemon-water or peroxide-water mix. Put both containers 124, 126 back and close the lid 104. For example, you'll have enough fluid in the back of the unit for 4-6 cycles (separate uses) for each time you fill up.

Remove the large round ball handled lid 102 from the top of the unit. Pull out (well #1) or (basket #1) 302, 508 from the main unit 100. Place the fruit and/or veggies into the well 302, 508 and put it back into the unit 100. Put the lid 102 back on.
1. Turn it on with on/off switch 106;
2. Twist the spin speed dial 114 on the front of the unit 100 to the desired speed. More delicate foods will need a slower speed. (i.e., berries)
3. Decide if you want cleaner. If you want cleaner 126, press the length of time 110 you want to wash the food with the cleaner 126 (30 sec., 1 min. or 2 min.). The amount of cleaner 126 used from the back of the unit will depend on how long you chose the wash the food.
4. If you choose cleaner 110, the rinse cycle will immediately follow. The rinse indicator light will go on while the cycle is running and will last about a minute. When the cycle is complete, the rinse light turns off.
5. You can choose just the rinse cycle 112, Hot or Cold. If you choose Hot, press the Hot button 116 and wait for the Red Hot Ready indicator light 118 to go on, then press rinse and then the start button 108.
   a. Note: You can sprinkle a little baking soda directly on the food before you start a cycle.
6. To dry the cleaned food, push down on the round ball 310 on the lid 102. If you're using (well #1) 302 with the center post 308, you will hear the center post 308 catch and lock 306 onto the lid 304. Once it's locked, press down on the ball 310 on the lid to spin dry your food. You will hear and feel it spinning. You control how fast and how long you want to spin dry by the speed and pressure you put on the lid. The harder and faster you push, the faster the food will spin dry. Push soft and slow and the food will spin slowly. Just a couple of pushes should remove any access water off most foods.

When the wash/rinse and spin dry cycles are completed, the food will be clean. The rinse indicator light will turn off and the water will automatically drain into the bottom drain pan 122.

Lift up on the lid knob 310. You'll hear the lid 304 and center post unlock 306. Remove the lid 102 and take the really clean food out of the well.

Prior to use, there is a drain pan hose attachment 207 that screws onto the back of the drain pan 122. The other end of the hose sets in the sink. That way, when the cycle is done, the water will drain into the pan and trickle down and through the hose 207 and into the sink.

After a few uses, if you didn't use the hose attachment 207, or you forgot to empty the pan, the drain pan warning light 120 will come on to let you know that the pan is full and needs to be emptied. To empty the drain pan 122, pull the handle 804, 806 from the front bottom of the unit 100. Take the pan 122 out and empty it into the sink. Then slide it back onto the unit 100.

The food is now clean and ready to eat or cook.

There is a (well #2) 508 or (basket #2) 508 without a center post for larger veggies and fruits, i.e., squash, lettuce, etc. The washing cycles work the same, however, the food will need to drip dry.

Both wells can wash different size dusty knick-knacks, eye glasses, some jewelry and the like. (Nothing with cooked food or crumbs, grimy dirt or things with chemicals, excluding fruits and veggies.)

The vegetable and fruit cleaner is designed to clean and sanitize fruit and veggies quicker and cleaner than hand washing them. There's a hot water feature designed to help remove waxes from foods such as apples and cucumbers. The manual push spin dry lid feature offers a more natural, energy efficient and quicker way to dry the food.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A produce cleaning system comprising:
a housing member defining a base, a sidewall, and an open unit cavity therebetween, the sidewall defining a water compartment and a cleansing compartment;
a basket configured to sit within the unit cavity and to receive produce;
a lid configured to close the open unit cavity;
one or more jet sprayers secured to an interior surface of the unit cavity and configured to selectively disperse fluids from the water compartment and cleansing compartment toward the basket, and
an interface configured to receive operation commands based on user input including a rinse command and cleansing command, the rinse command including instructions to direct the jet sprayers to disperse fluid from the water compartment, and the cleansing command including instructions to direct the jet sprayers to disperse fluids from both the water compartment and the cleansing compartment.

2. The produce cleaning system of claim 1, further comprising a spin mechanism supported by the base and configured to engage and spin the basket.

3. The produce cleaning system of claim 2, wherein the basket includes a center post with a center ring at one end and operatively connected to a spin latch at the other end, the spin latch configured to mate with the spinning mechanism, and the center ring configured to engage the lid such that the basket and lid rotate simultaneously.

4. The produce cleaning system of claim 2, wherein the spin mechanism is in communication with a motor that drives rotation of the spin mechanism.

5. The produce cleaning system of claim 4, wherein the motor is configured to receive a speed command including instructions from a spin speed dial to direct a speed at which the motor operates.

6. The produce cleaning system of claim 4, wherein the interface is further configured to active the one or more jet sprayers to disperse fluid while the motor drives rotation of the spin mechanism.

7. The produce cleaning system of claim 1, wherein the water compartment is configured to adjust a temperature of the fluid therein in response to a user pressing a hot button.

8. The produce cleansing system of claim 1, further comprising a removable drain pan configured to receive fluid from the unit cavity.

9. A produce cleansing device comprising:
a housing member defining a base, a sidewall, and an open unit cavity therebetween, the sidewall defining one or more fluid cavities configured to store fluid;
a spin mechanism supported by the base and including a receiving element;
a first basket configured to sit within the unit cavity and including a center post with a center ring at one end and operatively connected to a spin latch at the other end, the spin latch configured to mate with the receiving element such that the first basket rotates with the receiving element; and
a lid configured to close the open unit cavity and including a handle and a lock configured to engage the center ring;
a plurality of jet sprayers secured to an interior surface of the unit cavity, in fluid communication with the one or more fluid cavities, and configured to selectively activate,
wherein the plurality of jet sprayers are oriented such that fluid disperses therefrom in a plurality of trajectories to contact multiple sides of produce within the first basket.

10. The produce cleansing device of claim 9, further comprising a motor configured to drive the spin mechanism in response to instructions received from a spin speed dial.

11. The produce cleansing device of claim 10, wherein the jet sprayers are further configured to disperse fluid onto the produce while the spin mechanism is spinning the first basket.

12. The produce cleansing device of claim 9, further comprising a second basket configured to sit within the unit cavity and including a second spin latch configured to mate with the receiving element such that the second basket rotates with the receiving element, wherein the plurality of jet sprayers are oriented such that fluid disperses therefrom in a plurality of trajectories to contact multiple sides of produce within the second basket.

13. The produce cleansing device of claim 9, wherein the sidewall further defines one or more inlet ports configured to receive a fluid supply line to transfer fluid from an external fluid source to the one or more fluid cavities.

14. The produce cleansing device of claim 9, wherein the center post defines one or more tracks configured to receive a portion of one or more dividers.

15. The produce cleansing device of claim 9, wherein the base further defines a drain pan cavity in fluid communication with the unit cavity and configured to receive a removable drain pan.

16. A method for cleansing produce with a produce cleansing device:
placing produce within a basket positioned within a unit cavity of the device and engaged with a spin mechanism of the device;
in response to user input to a speed spin dial, a motor activating to spin the spin mechanism and basket engaged therewith, and in response to user input to a start button, one or more jet sprayers positioned within the unit cavity and in communication with a fluid source activating to disperse fluid therefrom on multiple portions of the produce as the basket spins.

17. The method for cleansing produce of claim 16, additionally comprising transferring a cleaning solution and water contained within the device in one or more compartments to the jet sprayers.

18. The method for cleansing produce of claim 16, wherein the basket is configured to receive one or more dividers to separate produce.

19. The method for cleansing produce of claim 16, additionally comprising operating the motor at more than one spin speed based on instructions received from an interface.

20. The method for cleansing produce of claim 19, additionally comprising operating the motor and jet sprayers at predetermined time thresholds.
